(19) United States
(12) Patent Application Publication
(10) Pub. No.: US 2011/0246037 A1
(43) Pub. Date: Oct. 6, 2011

(54) HYDRAULIC CONTROL APPARATUS FOR LOCKUP CLUTCH

(75) Inventors: Tetsuya SHIMIZU, Anjo-shi (JP); Kenichi Tsuchida, Hazu-gun (JP); Kazunori Ishikawa, Toyota-shi (JP)

(73) Assignee: AISIN AW CO., LTD., Anjo-shi (JP)

(21) Appl. No.: 13/034,110

(22) Filed: Feb. 24, 2011

(30) Foreign Application Priority Data
Mar. 31, 2010 (JP) 2010-084228

(51) Int. Cl. F16D 48/06; F16D 25/00

(52) U.S. Cl. 701/68; 192/85.01

(57) ABSTRACT

A hydraulic pressure control apparatus for a lockup clutch of a fluid transmission device. In a spool of the lockup relay valve, switching to a position on an engaging side (right half position) for engaging a lockup clutch is achieved by a signal pressure being input from a linear solenoid valve to a hydraulic oil chamber, and switching to a position on a releasing side (left half position) for releasing the lockup clutch is achieved by an urging member such as a spring force of a spring. Since the response is low with the switching by the spring force, the state of a vehicle is sensed by a sensor and, if quick release of the lockup clutch is necessary, a signal pressure from a solenoid valve is input to a hydraulic oil chamber to apply the spring force, and assists with a hydraulic pressure, thereby switching the spool to the releasing side. Accordingly, the response when the lockup relay valve is switched from the engaging side to the releasing side is enhanced.

### INCORPORATION BY REFERENCE

The disclosure of Japanese Patent Application No. 2010-084228 filed on Mar. 31, 2010, including the specification, drawings and abstract thereof, is incorporated herein by reference in its entirety.

### BACKGROUND OF THE INVENTION

1. Field of the Invention

The present invention relates to a hydraulic control apparatus for a lockup clutch of an automatic transmission mounted on a vehicle or the like and, more specifically, to a hydraulic control apparatus for a lockup clutch which is improved in response of a switching device when switching the lockup clutch from an engaging side (ON side) to a releasing side (OFF side).

2. Description of the Related Art

Recently, a torque converter of an automatic transmission mounted on a vehicle or the like is provided with a lockup clutch for the purpose of favorable gas mileage in many cases. The lockup clutch is generally classified into a multiple disk type and a single disk type which is disclosed for example in JP-A-2009-121623.

The one disclosed in JP-A-2009-121623 includes a lockup relay valve (switching device) which is switched to an engaging side (ON side) and a releasing side (OFF side). When the lockup relay valve is switched to the engaging side, a hydraulic pressure (engaging hydraulic pressure) is supplied to an engaging-side oil chamber via a first oil channel, and a hydraulic pressure (releasing hydraulic pressure) is discharged from a releasing-side oil chamber via a second oil channel. Accordingly, a lockup clutch is engaged and hence a pump impeller and a turbine runner are directly coupled, whereby the revolution of an engine is input to an input shaft of the automatic transmission mechanism directly without the intermediary of fluid. On the other hand, in contrast, if it is switched to the releasing side, the hydraulic pressure is discharged from the engaging-side oil chamber via the first oil channel, and the hydraulic pressure is supplied to the releasing-side oil chamber via the second oil channel. Accordingly, the lockup clutch is released.

The switching of the lockup relay valve from the releasing side to the engaging side is achieved from a linear solenoid valve via the hydraulic pressure, and that from the engaging side to the releasing side is achieved via a spring force of a spring in contrast.

### SUMMARY OF THE INVENTION

However, according to JP-A-2009-121623, for example, when the oil temperature is low and hence the oil pressure can hardly be discharged from the oil channel, response of the switching device (lockup relay valve) may be lowered at the time of switching from the engaging side to the releasing side depending on the spring force of the spring.

Then, when the response from the engaging side to the releasing side is lowered, timing of disengagement of the lockup clutch is delayed. Therefore, for example, when a sudden brake is applied at a low vehicle speed or a low torque, the number of revolutions of the engine which is directly coupled thereto is lowered in association with the lowering of the number of revolutions of the input shaft of the automatic transmission mechanism. Accordingly, there is a risk of occurrence of knocking, which may make a driver feel discomfort in operation feeling.

Accordingly, it is an object of the present invention to provide a hydraulic control apparatus for a lockup clutch improved in response of a switching device by switching the switching device from the engaging side to the releasing side by the assistance of hydraulic pressure in addition to a spring force of a spring so that the feeling of discomfort in the operation feeling is reduced.

According to a first aspect of the invention, since a switching device can be urged in the same direction as an urging direction of an urging member with a second signal pressure in addition to the urging member when the switching from a position on an engaging side to a position on a releasing side, response of the switching device can be enhanced.

According to a second aspect of the invention, a state of a vehicle can be determined by a determination means, an evaluation means can evaluate whether the second signal pressure is required or not on the basis of the result of determination, and a control unit can instruct the generation of the second signal pressure to a second signal pressure output unit on the basis of the result of evaluation. The second signal pressure is output by the instruction of a control means, so that output can be made only when required and unnecessary output can be prevented. Therefore, gas mileage can be reduced.

According to a third aspect of the invention, when the number of engine revolutions is lowered to a value not higher than a predetermined value, a lockup clutch can be released quickly by enhancing the response of the switching device. Therefore, the feeling of discomfort in the operation feeling can be eliminated by preventing occurrence of knocking or the like in advance when the number of engine revolutions is lowered.

According to a fourth aspect of the invention, when the vehicle speed is lowered to a value not higher than a predetermined value, the lockup clutch can be released quickly by enhancing the response of the switching device. Therefore, the feeling of discomfort in the operation feeling can be eliminated by preventing occurrence of knocking or the like in advance when the vehicle speed is lowered.

According to a fifth aspect of the invention, when a sudden stop of the vehicle is evaluated, the lockup clutch can be released quickly by enhancing the response of the switching device. Therefore, the feeling of discomfort in the operation feeling can be eliminated by preventing occurrence of knocking or the like in advance at the time of the sudden stop.

According to a sixth aspect of the invention, when the road surface is evaluated to be a low-friction road surface, the lockup clutch can be released quickly by enhancing the response of the switching device. Therefore, the feeling of discomfort in the operation feeling can be eliminated by preventing occurrence of knocking or the like in advance in a case where a specific wheel is slipped and hence is locked on the low-friction road surface (low μ road) having a low coefficient of friction such as snowy roads, for example.

According to a seventh aspect of the invention, the lockup clutch can be released quickly by enhancing the response of the switching device when it is evaluated that a brake is depressed. Alternatively, the lockup clutch can be released quickly by enhancing the response of the switching device when it is evaluated that the road surface is the low-friction road surface and that the brake is depressed.

According to an eighth aspect of the invention, when the evaluation means evaluates the difference in number of revolutions between a pump impeller and a turbine runner to be not lower than a predetermined value in a state in which the issue of a first signal pressure is not instructed by the control means, for example, the lockup clutch can be released quickly by evaluating it to be a failure of a hydraulic pressure circuit relating to lockup control and enhancing the response of the switching device.

### BRIEF DESCRIPTION OF THE DRAWINGS

FIG. 1 is a skeleton drawing showing an automatic transmission according to the present invention;

FIG. 2 is a table of engagement of the automatic transmission;

FIG. 3 is a circuit diagram showing a hydraulic control apparatus for a lockup clutch according to a first embodiment;

FIG. 4 is a block diagram of the hydraulic control apparatus for the lockup clutch according to the first embodiment;

FIG. 5 is a flowchart for explaining a flow of control of the hydraulic control apparatus according to the first embodiment;

FIG. 6 is a flowchart for explaining the flow of control of the hydraulic control apparatus according to the first embodiment;

FIG. 7 is a flowchart for explaining the flow of control of the hydraulic control apparatus according to the first embodiment; and

FIG. 8 is a circuit diagram showing a hydraulic control apparatus for the lockup clutch according to a second embodiment.

### DETAILED DESCRIPTION OF THE EMBODIMENTS

### First Embodiment

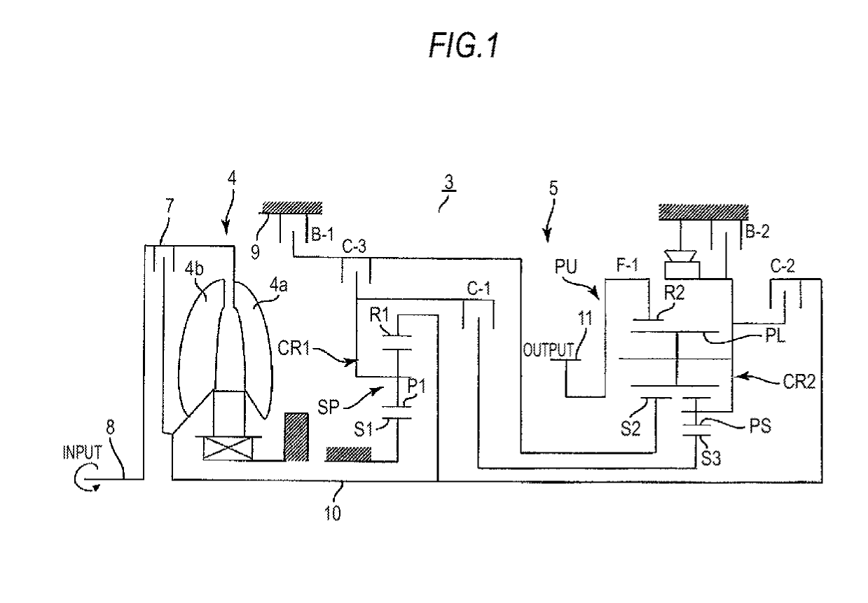

Referring now to FIG. 1 to FIG. 7, a first embodiment of the present invention will be described.

[General Configuration of Automatic Transmission]

Referring first to FIG. 1, a general configuration of an automatic transmission 3 to which a hydraulic control apparatus for a lockup clutch according to the present invention can be applied will be described. As shown in FIG. 1, the automatic transmission 3 suitable to be used in, for example, a vehicle of FF type (front engine, front drive) includes an input shaft 8 of the automatic transmission 3 which can be connected to an engine (not shown), and includes a torque converter 4 and an automatic transmission mechanism 5 with an axial direction of the input shaft 8 as a center.

The aforementioned torque converter 4 includes a pump impeller 4a connected to the input shaft 8 of the automatic transmission 3, and a turbine runner 4b to which the rotation of the pump impeller 4a is transmitted via hydraulic fluid, and the turbine runner 4b is connected to an input shaft 10 of the aforementioned automatic transmission mechanism 5 disposed coaxially with the aforementioned input shaft 8. The torque converter 4 is provided with a lockup clutch 7 and, when the lockup clutch 7 is engaged, the rotation of the input shaft 8 of the aforementioned automatic transmission 3 is directly transmitted to the input shaft 10 of the automatic transmission mechanism 5. The lockup clutch 7 and the like will be described later in detail.

The aforementioned automatic transmission mechanism 5 includes a planetary gear SP and a planetary gear unit PU on the input shaft 10. The aforementioned planetary gear SP is so-called a single pinion planetary gear including a sun gear S1, a carrier CR1, and a ring gear R1, and the carrier CR1 includes a pinion P1 which engages the sun gear S1 and the ring gear R1.

The planetary gear unit PU is so-called a ravigneaux type planetary gear configured in such a manner that a sun gear S2, a sun gear S3, a carrier CR2, and a ring gear R2 are provided as four rotation elements, and the carrier CR2 includes a long pinion PL which engages the sun gear S2 and the ring gear R2 and a short pinion PS which engages the sun gear S3 in a form of being engaged with respect to each other.

The sun gear S1 of the planetary gear SP is connected, to a boss portion, not shown, fixed integrally to a transmission case 9, whereby the rotation thereof is fixed. The aforementioned ring gear R1 performs the same rotation as the rotation of the input shaft 10 (hereinafter, referred to as “input rotation”). In addition, the carrier CR1 performs a decelerated rotation which is decelerated from the input rotation by the fixed sun gear S1 and the ring gear R1 which performs the input rotation, and is connected to a clutch C-1 and a clutch C-3.

The sun gear S2 of the aforementioned planetary gear unit PU is connected to a brake (frictional engagement element) B-1 and is freely fixable with respect to the transmission case 9, and is connected to the aforementioned clutch C-3, whereby the decelerated rotation of the aforementioned carrier CR1 via the aforementioned clutch C-3 can be input freely. The aforementioned sun gear S3 is connected to the clutch (frictional engagement element) C-1, so that the decelerated rotation of the carrier CR1 can be input freely.

In addition, the aforementioned carrier CR2 is connected to a clutch C-2 to which the rotation of the input shaft 10 is input, so that the input rotation can be input freely via the clutch C-2, and is connected to an one-way clutch F-1 and a brake B-2 so that the rotation thereof in one direction with respect to the transmission case 9 is restrained by the one-way clutch F-1, and the rotation thereof can be fixed freely via the brake B-2. Then, the aforementioned ring gear R2 is connected to a counter gear 11, and the counter gear 11 is connected to a drive wheel via a counter shaft and a differential device, not shown.

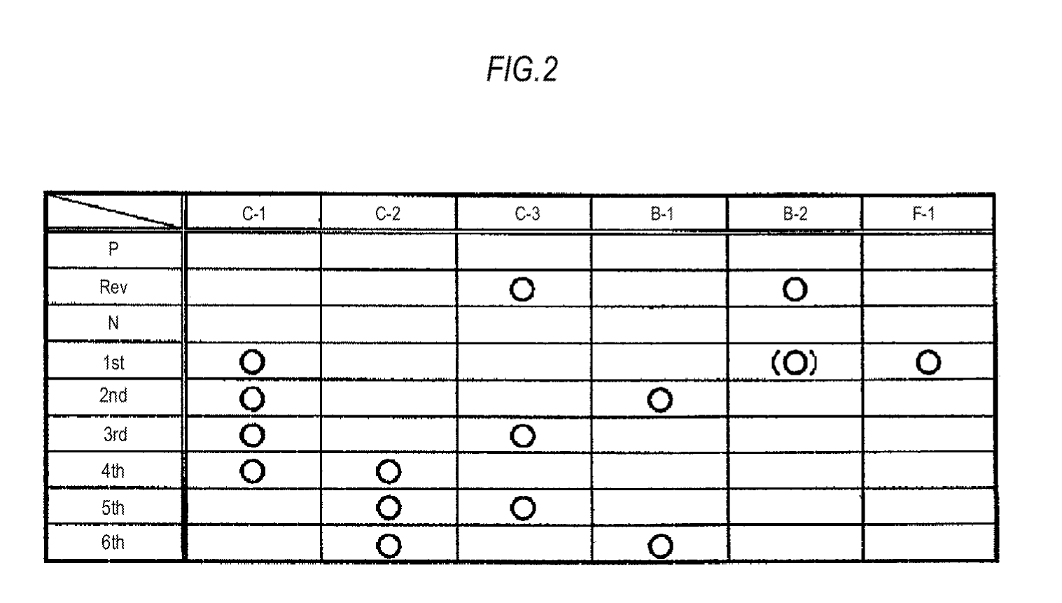

The automatic transmission 3 configured as described above achieves an forward first gear (1st) to an forward sixth gear (6th) and a reverse first gear (Rev) by engagement and disengagement of the respective clutches C-1 to C-3, the brake B-1, B-2, and a one-way clutch F1 shown in the skeleton in FIG. 1 in combinations shown in a table of engagement in FIG. 2.

[General Configuration of Hydraulic Control Apparatus]

Subsequently, a hydraulic control apparatus 1₁ for an automatic transmission including a hydraulic control apparatus 2 for a lockup clutch according to the present invention will be described. First of all, parts which generate a line pressure P_{L}, a secondary pressure P_{SEC}, a modulator pressure P_{MOD}, a D-range pressure P_{D}, a R-range pressure P_{REV} in the hydraulic control apparatus 1₁ will be roughly described. Since the parts which generate the line pressure P_{L}, the secondary pressure P_{SEC}, the modulator pressure P_{MOD}, the D-range pressure (forward range pressure) P_{D}, the R-range pressure (reverse range pressure) P_{REV} and so on are the same as those in the hydraulic control apparatus for a general automatic transmission and is known in public, description will be given briefly.

The hydraulic control apparatus 1₁ includes, for example, a manual valve, an oil pump, a primary regulator valve, a secondary regulator valve, a solenoid modulator valve, not shown, linear solenoid valves SL1-SL4, SLU, relay valves 22-29, solenoid valves S1, S2, and so on, described later in detail. For example, when the engine is started, for example, the oil pump coupled to the pump impeller 4a of the aforementioned torque converter 4 is driven in conjunction with the revolution of the engine, so that a hydraulic pressure is generated by sucking oil from an oil pan, not shown, via a strainer.

The hydraulic pressure generated by the aforementioned oil pump is subjected to a pressure regulation to the line pressure P_{L} while being subject to a discharge adjustment by the primary regulator valve on the basis of a signal pressure P_{DLT} of the linear solenoid valve adjusted in pressure and output according to a throttle opening. The line pressure P_{L} is supplied to a manual valve (range switching valve), a solenoid modulator valve, and a linear solenoid valve SLC3, described later in detail, and so on. The line pressure P_{L} supplied to the solenoid modulator valve among these is regulated in pressure to the modulator pressure P_{MOD}, which is adjusted to a substantially constant pressure by the valve, and the modulator pressure P_{MOD} is supplied as an original pressure for the linear solenoid valve SLU, the solenoid valves S1, S2, and so on, described later in detail.

The pressure discharged from the aforementioned primary regulator valve is regulated to the secondary pressure P_{SEC} while being subjected to the further discharge adjustment, for example, by the secondary regulator valve, and the secondary pressure P_{SEC} is supplied to a lubricant channel or an oil cooler 36 or the like via the lockup relay valve 28, which will be described later in detail, for example, is also supplied to the torque converter 4, and is used for the control of the lockup clutch 7.

In contrast, the manual valve (not shown) as a range pressure output unit for outputting the range pressure such as the D-range pressure P_{D} and the R-range pressure P_{REV} includes a spool mechanically (or electrically) driven by the operation of a shift lever provided at a driver's seat, and the output state or a non-output state (drain) of the aforementioned input line pressure P_{L} is set by the position of the spool being switched according to the shift ranges (for example, P range, R range, N range, D range) selected using the shift lever. For example, when the manual valve is switched to the D-range, the input line pressure P_{L} is output as the D-range pressure P_{D}, and when it is switched to the R-range, the input line pressure P_{L} is output as the R-range pressure P_{REV}. Then, when the manual valve is switched to the P-range or the N-range, the D-range pressure P_{D} or the R-range pressure P_{REV} is drained (discharged), and the non-output state is assumed.

[Detailed Configuration of Transmission Control Parts in Hydraulic Control Apparatus]

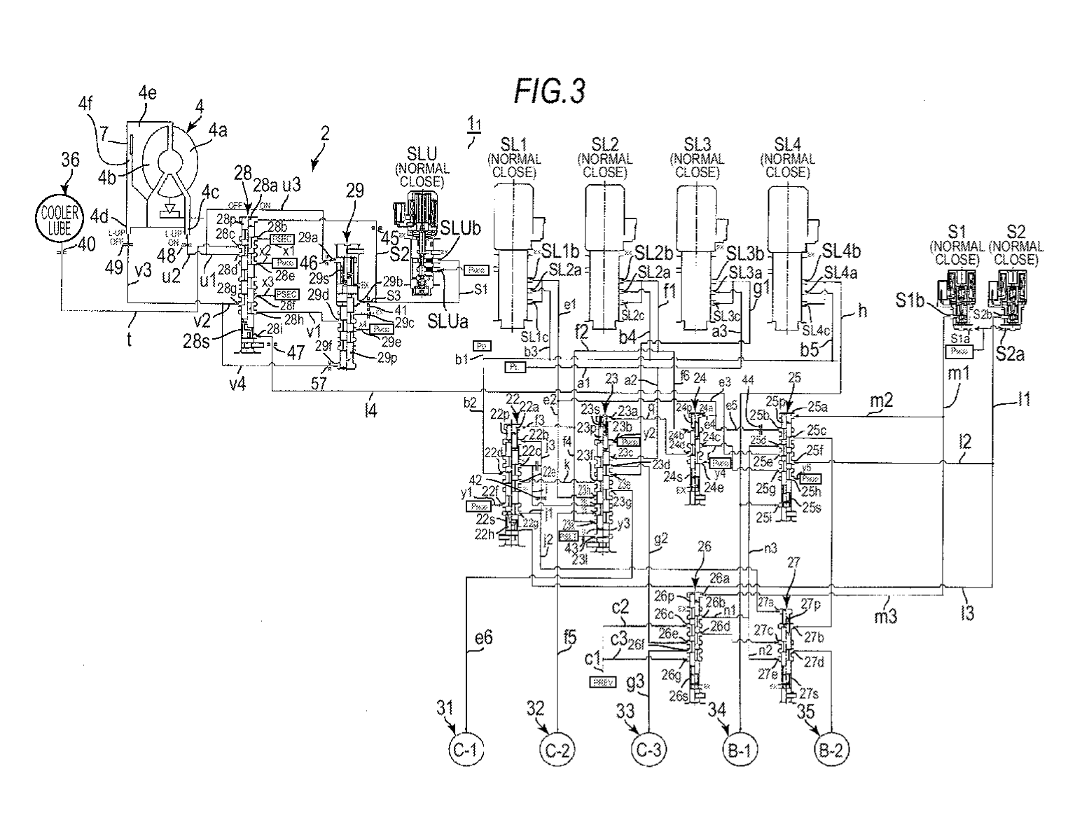

Referring next to FIG. 3, parts which mainly perform transmission control in the hydraulic control apparatus 1₁ of the automatic transmission will be described. In this embodiment, in order to describe the spool position, the position on the right half in FIG. 3 is referred to as “right half position”, and the position in the left half is referred to as “left half position”. A detailed configuration of the hydraulic control apparatus 2 of the lockup clutch will be described together later in detail.

The hydraulic control apparatus 1₁ includes the four linear solenoid valves SL1, SL2, SL3, SL4 for supplying a control pressure regulated as the engaging pressure directly to five hydraulic servos 31-35 respectively in total including the hydraulic servo 31 of the clutch C-1, the hydraulic servo 32 of the clutch C-2, the hydraulic servo 33 of the clutch C-3, the hydraulic servo 34 of the brake B-1, and the hydraulic servo 35 of the brake B-2 described above, and further includes a portion which achieves a reverse inhibit function, a part to achieve a limp home function, and a part constituting the hydraulic control apparatus 2 of the lockup clutch.

The aforementioned linear solenoid valves SL1, SL2, SL3, SL4 are all valves of normally close type, which are brought into an output state when being energized, and includes input ports SL1a, SL2a, SL3a, SL4a respectively to which the original pressure is input, output ports SL1b, SL2b, SL3b, SL4b configured to output control pressures P_{SL1}, P_{SL2}, P_{SL3}, P_{SL4} regulated from the original pressure as the engaging pressure to the hydraulic servos 31, 32, 33, 34, 35, and input ports SL1c, SL2c, SL3c, SL4c configured to receive feedback of the control pressures P_{SL1}, P_{SL2}, P_{SL3}, P_{SL4}.

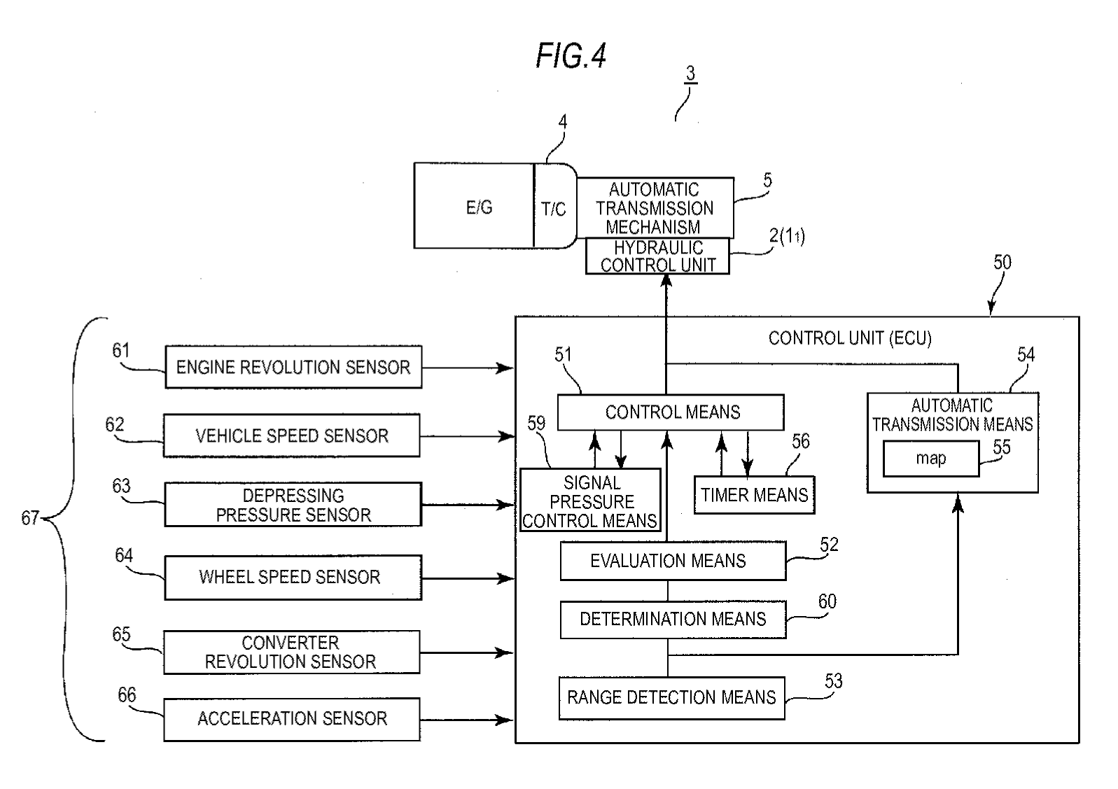

In other words, the linear solenoid valves SL1, SL2, SL3, SL4 assume the non-output state in which the input ports SL1a, SL2a, SL3a, SL4a and the output ports SL1b, SL2b, SL3b, SL4b are blocked when not being energized. In contrast, when being energized on the basis of a command value from a control unit (ECU) 50 (see FIG. 4), and increases the amounts of opening (amounts of communication) of the respective input ports SL1a, SL2a, SL3a, SL4a and the respective output ports SL1b, SL2b, SL3b, SL4b according to the command value to allow the output of the control pressure (engaging pressure) according to the command value.

Also, the hydraulic control apparatus 1₁ includes the C3-B2 apply control valve 26 which divides engaging pressures Pₒ, P_{B2} to the hydraulic servo 33 of the clutch C-3 and the hydraulic servo 35 of the brake B-2, the B2 apply control valve 27 configured to switch the supply of the engaging pressure P_{B2} to the hydraulic servo 35 of the brake B-2, and the solenoid valve S1 and the solenoid valve S2 configured to output signal pressures P_{S1}, P_{S2} for switching these valves 26, 27 between the linear solenoid valves SL1-SL4 and the respective hydraulic servos 31-35 as parts which achieve the reverse inhibit function.

Furthermore, the hydraulic control apparatus 1₁ includes, in addition to the C3-B2 apply control valve 26, the B2 apply control valve 27, and the solenoid valves S1, S2, the first clutch apply relay valve 23 switched at the time of a solenoid-all-off-fail (hereinafter, referred to simply as “at the time of fail”), the second clutch apply relay valve 22 switched between low-speed gears (forward first gear to forward third gear) and high-speed gears (forward fourth gear to forward sixth gear), and the first solenoid relay valve 24 and the second solenoid relay valve 25 configured to output the modulator pressure P_{MOD} to the first clutch apply relay valve 23 as the signal pressure between the linear solenoid valves SL1-SL4 and the respective hydraulic servos 31-35 as parts which achieve the limp home function.

Furthermore, the hydraulic control apparatus 1₁ also includes the linear solenoid valve SLU, the lockup relay valve 28, the lockup control valve 29, and the linear solenoid valves S1, S2, and so on as the hydraulic control apparatus 2 of the lockup clutch 7.

The hydraulic control apparatus 1₁ is configured in such a manner that the line pressure P_{L} from the primary regulator valve (not shown) is input to oil channels a1-a3 shown in the vicinity of the linear solenoid valve SL2 in the drawing, and the oil channel a1 is connected to an input port 23c of the first clutch apply relay valve 23 via the oil channel a2 and is connected to the input port SL3a of the linear solenoid valve SL3 via the oil channel a3.

Also, oil channels b1-b5 are configured to allow input of the D-range pressure P_{D} from the manual valve as the original pressure of the above-described linear solenoid valves SL1, SL2, SL4, and the oil channel b1 is connected to the input port 22d of the second clutch apply relay valve 22 via the oil channel b2 and is connected to the input ports SL1a, SL2a, SL4a of the linear solenoid valves SL1, SL2, SL4 via the oil channels b3, b4, b5.

Then, the output port SL1b of the linear solenoid valve SL1 from among the output ports SL1b-SL4b of the linear solenoid valves SL1-SL4 configured to output the regulated line pressure P_{L} or the D-range pressure P_{D} is connected to an input port 23h of the first clutch apply relay valve 23 via oil channels e1, e2 and is connected to the hydraulic oil chamber 24a of the first solenoid relay valve 24 via the oil channels e1, e3, d4, and is also connected to an input port 25b of the second solenoid relay valve 25 via the oil channels e1, e3, e5 and an orifice 44.

Also, the output port SL2b of the linear solenoid valve SL2 is connected to an input port 23k of the first clutch apply relay valve 23 via oil channels f1, f2, f4, is connected to a hydraulic oil chamber 22a of the second clutch apply relay valve 22 via the oil channels f1, f2, f3, and is connected to a hydraulic oil chamber 24b of the first solenoid relay valve 24 via the oil channels f1, f6.

Furthermore, the output port SL3b of the linear solenoid valve SL3 is connected to an input port 23e of the first clutch apply relay valve 23 via an oil channel g1, and the output port SL4b of the linear solenoid valve SL4 is connected directly to the hydraulic servo 34 of the brake B-1 via an oil channel h.

Both of the aforementioned solenoid valves S1, S2 are valves of normally closed type configured to communicate input ports S1a, S2a with the output ports S1b, S2b respectively to output the modulator pressure P_{MOD} input to the input ports S1a, S2a from the output ports S1b, S2b as the signal pressure when being energized, while not to cause the signal pressure to be output when not being energized.

The output port S1b of the aforementioned solenoid valve S1 is connected to a hydraulic oil chamber 25a of the second solenoid relay valve 25 via oil channels m1, m2, and is connected to a hydraulic oil chamber 26a of the C3-B2 apply control valve 26 via the oil channels m1, m3. The output port S2b of the aforementioned solenoid valve S2 is connected to an input port 25f of the second solenoid relay valve 25 via oil channels 11, 12, and is connected to a hydraulic oil chamber 22h of the second clutch apply relay valve 22 via the oil channels 11, 13.

The aforementioned second clutch apply relay valve 22 includes a spool 22p and a spring 22s which urges the spool 22p upward in the drawing, and includes the hydraulic oil chamber 22a upward of the spool 22p in the drawing, the hydraulic oil chamber 22h downward of the spool 22p in the drawing, and a hydraulic oil chamber 22b formed by difference in land diameter of the spool 22p (the difference in pressure receiving surface area), and further includes an output port 22c, an input port 22d, an output port 22e, and an input port 22f in sequence from above in the drawing, and includes a drain port EX outside thereof.

In the second clutch apply relay valve 22, the spool 22p is switched to the right half position (the position on the side of the high-speed gears) and the left half position (the position on the side of the low-speed gears) according to the presence or absence of input of a signal pressure P_{SL2} to the hydraulic oil chamber 22a. In other words, the spool 22p stands in the right half position against an urging force from the spring 22s when the signal pressure P_{SL2} output from the linear solenoid valve SL2 corresponding to the high-speed gears (forward fourth gear to forward sixth gear) is input to the aforementioned hydraulic oil chamber 22a via the oil channels f1, f2, f3, and stands in the left half position by the urging force of the spring when it is not input (non-input).

In the second clutch apply relay valve 22, the input port 22d communicates with the output port 22c and is blocked from the output port 22e corresponding to the right half position of the spool 22p. Accordingly, the oil channels b1, b2 which are connected to the input port 22d and receive the input of the D-range pressure P_{D} are brought into communication with an input port 23i of the first clutch apply relay valve 23 via the input port 22d, the output port 22c, and an oil channel i. Also, in the same manner, the input port 22f is brought into communication with an output port 22g corresponding to the right half position of the spool 22p, whereby an oil channel y1 connected to the input port 22f to receive an input of the modulator pressure P_{MOD} is brought into communication with a hydraulic oil chamber 27a of the B2 apply control valve 27 via the input port 22f, the output port 22g, and oil channels j1, j2, and is brought into communication with the oil chamber 22b via an oil channel j3 branched from the oil channel j1 and an orifice 42.

In contrast, in the second clutch apply relay valve 22, the input port 22d is brought into communication with the output port 22e and is blocked from the output port 22c corresponding to the left half position of the spool 22p. Accordingly, the oil channels b1, b2 which are connected to the input port 22d and receive the input of the D-range pressure P_{D} are brought into communication with an input port 23f of the first clutch apply relay valve 23 via the input port 22d, the output port 22e, and an oil channel k. The hydraulic oil chamber 22h is brought into communication with the output port S2b of the solenoid valve S2 via oil channels 11, 13, and is brought into communication with the output port 22g corresponding to the left half position of the spool 22p.

The aforementioned first clutch apply relay valve 23 includes a spool 23p and a spring 23s which urges the spool 23p downward in the drawing, and includes a hydraulic oil chamber 23a upward of the spool 23p in the drawing, a hydraulic oil chamber 23l downward of the spool 23p in the drawing, and a hydraulic oil chamber 23b formed by difference in land diameter of the spool 23p (the difference in pressure receiving surface area), and further includes the input port 23c, the output port 23d, an input port 23e, the input port 23f, an output port 23g, the input port 23h, the input port 23i, an output port 23j, and the input port 23k in sequence from above in the drawing.

In the first clutch apply relay valve 23, the spool 23p is switched to the right half position (position in the normal state) and the left half position (position at the time of fail) according to the presence or absence of input of the signal pressure to the hydraulic oil chamber 23a. In the first clutch apply relay valve 23, in the normal state, the modulator pressure P_{MOD} is input to the hydraulic oil chamber 23a as a signal pressure via an oil channel q as described later, and the modulator pressure P_{MOD} is input to the hydraulic oil chamber 23b via an oil channel y2, and the signal pressure P_{SLT} from the linear solenoid valve is input to the hydraulic oil chamber 23l via an oil channel y3 and an orifice 43. In this state, the spool 23p stands in the right half position (normal position) by the urging force of the spring 23s. In contrast, at the time of fail, since the modulator pressure P_{MOD} is not input to the hydraulic oil chamber 23a, the left half position (position at the time of fail) is assumed against the urging force of the spring 23s by the signal pressure P_{SLT}.

In the first clutch apply relay valve 23, the input port 23h is brought into communication with the output port 23g corresponding to the right half position of the spool 23p, whereby the output port SL1b of the linear solenoid valve SL1 is brought into communication with the hydraulic servo 31 via the oil channels e1, e2, the input port 23h, the output port 23g, and an oil channel e6. Also, in the same manner, the input port 23k is brought into communication with the output port 23j corresponding to the right half position of the spool 23p, whereby the output port SL2b of the linear solenoid valve SL2 is brought into communication with the hydraulic servo 32 via the oil channels f1, f2, f4, the input port 23k, the output port 23j, and an oil channel f5.

Furthermore, in the same manner, the input port 23e is brought into communication with the output port 23d corresponding to the right half position of the spool 23p, whereby the output port SL3b of the linear solenoid valve SL3 is brought into communication with an input port 26e of the C3-B2 apply control valve 26 via the oil channel g1, the input port 23e, the output port 23d, and an oil channel g2.

Although detailed description will be given later, the input port 26e is brought into communication with the hydraulic servo 33 corresponding to the left half position of a spool 26p of the C3-B2 apply control valve 26 and, in contrast, is brought into communication with the hydraulic servo 35 at the right half position of a spool 26p of the C3-B2 apply control valve 26 and corresponding to the left half position of a spool 2′7p of the B2 apply control valve 27. The above-described communication relationships corresponding to the right half position of the spool 23p, that is, the communication between the input port 23h and the output port 23g, the communication between the input port 23k and the output port 23j, and the communication between the input port 23e and the output port 23d are broken away when the spool 23p is switched to the left half position.

In contrast, in the first clutch apply relay valve 23, the input port 23f is brought into communication with the output port 23g corresponding to the left half position of the spool 23p, whereby the output port 22e of the second clutch apply relay valve 22 is brought into communication with the hydraulic servo 31 via the oil channel k, the input port 23f, the output port 23g, and the oil channel e6. Also, in the same manner, the input port 23i is brought into communication with the output port 23j corresponding to the left half position of the spool 23p, whereby the output port 22c of the second clutch apply relay valve 22 is brought into communication with the hydraulic servo 32 via the oil channel i, the input port 23i, the output port 23j, and the oil channel f5.

Furthermore, in the same manner, the input port 23c is brought into communication with the output port 23d corresponding to the left half position of the spool 23p, whereby the oil channel a1 which receives an input of the line pressure P_{L} is brought into communication with the input port 26e of the C3-B2 apply control valve 26 via the oil channel a2, the input port 23c, the output port 23d, and the oil channel g2. The above-described communication relationships corresponding to the left half position of the spool 23p, that is, the communication between the input port 23f and the output port 23g, the communication between the input port 23i and the output port 23j, and the communication between the input port 23c and the output port 23d are broken away when the spool 23p is switched to the right half position.

The first solenoid relay valve 24 includes a spool 24p and a spring 24s which urges the spring 24s upward in the drawing, and includes the hydraulic oil chamber 24a upward of the spool 24p in the drawing, and the hydraulic oil chamber 24b formed by the difference in land diameter of the spool 24p (the difference in pressure receiving surface area), and further includes an input port 24c, an output port 24d, and an input port 24e in sequence from above in the drawing.

The output port SL1b of the aforementioned linear solenoid valve SL1 is connected to the aforementioned hydraulic oil chamber 24a via the oil channels e1, e3, and the output port SL2b of the aforementioned linear solenoid valve SL2 is connected to the aforementioned hydraulic oil chamber 24b via the oil channels f1, f6. In the first solenoid relay valve 24, when the total signal pressure P_{SL1}, P_{SL2} (engaging pressure) input to the hydraulic oil chambers 24a, 24b respectively from the linear solenoid valves SL1, SL2 is not smaller than a predetermined value, the spool 24p stands in the right half position against an urging force of the spring 24s, and when it is smaller than the predetermined value, the spool 24p stands in the left half position by the urging force of the spring 24s.

In the first solenoid relay valve 24, the input port 24e is brought into communication with the output port 24d corresponding to the right half position of the spool 24p, whereby an oil channel y4 which receives an input of the modulator pressure P_{MOD} is brought into communication with the hydraulic oil chamber 23a of the first clutch apply relay valve 23 via the input port 24e, the output port 24d, and further the oil channel q.

In contrast, in the first solenoid relay valve 24, the input port 24c is brought into communication with the output port 24d corresponding to the left half position of the spool 24p, whereby an output port 25g of the second solenoid relay valve 25 is brought into communication with the hydraulic oil chamber 23a of the first clutch apply relay valve 23 via an oil channel r, the input port 24c, the output port 24d, and the oil channel q. The communication between the input port 24c and the output port 24d is broken away corresponding to the right half position of the spool 24p, and the communication between the input port 24e and the output port 24d is broken away corresponding to the left half position.

The second solenoid relay valve 25 includes a spool 25p and a spring 25s which urges the spool 25p upward in the drawing, and includes the hydraulic oil chamber 25a upward of the spool 25p in the drawing, and a hydraulic oil chamber 25i downward of the spool 25p in the drawing, and further includes the input port 25b, an output port 25c, an input port 25d, an output port 25e, an input port 25f, an output port 25g, and an input port 25h in sequence from above in the drawing.

The output port S1b of the solenoid valve S1 is connected to the hydraulic oil chamber 25a via the oil channels m1, m2. When the signal pressure P_{S1} (the modulator pressure P_{MOD}) output from the output port S1b is input to the hydraulic oil chamber 25a via the oil channels m1, m2 by energizing the solenoid valve S1, the spool 25p stands in the right half position against an urging force of the spring 25s, and stands in the left half position by non-input of the signal pressure P_{S1} by non-energization of the solenoid valve S1.

In the second solenoid relay valve 25, the input port 25d is brought into communication with the output port 25c corresponding to the right half position of the spool 25p, whereby an output port 26b of the C3-B2 apply control valve 26 is brought into communication with a hydraulic oil chamber 27b of the B2 apply control valve 27 via oil channels n1, n3, the input port 25d, the output port 25c, and an oil channel e7. Also, in the same manner, the input port 25f is brought into communication with the output port 25e corresponding to the right half position of the spool 25p, whereby the output port S2b of the solenoid valve S2 is brought into communication with a hydraulic oil chamber 28i of the lockup relay valve 28 via the oil channels 11, 12, the input port 25f, the output port 25e, an oil channel 14, and an orifice 47.

Furthermore, in the same manner, the input port 25h is brought into communication with the output port 25g corresponding to the right half position of the spool 25p, whereby an oil channel y5 which receives the input of the modulator pressure P_{MOD} is brought into communication with the input port 24c of the first solenoid relay valve 24 via the input port 25h, the output port 25g, and the oil channel r.

In contrast, in the second solenoid relay valve 25, the input port 25b is brought into communication with the output port 25e corresponding to the left half position of the spool 25p, whereby the output port SL1b of the linear solenoid valve SL1 is brought into communication with the hydraulic oil chamber 27b of the B2 apply control valve 27 via the oil channels e1, e3, e4, the orifice 44, the input port 25b, the output port 25c, and the oil channel e7. Also, in the same manner, the input port 25d is brought into communication with the output port 25e corresponding to the left half position of the spool 25p, whereby an input port 27e of the B2 apply control valve 27 is brought into communication with the input port 24c of the first solenoid relay valve 24 via an oil channel p, the input port 25d, the output port 25e, and the oil channel r. The communication between the input port 25b and the output port 25c, and the communication between the input port 25d and the output port 25e are broken away corresponding to the right half position of the spool 25p, and the communication between the input port 25d and the output port 25c, the communication between the input port 25f and the output port 25e, and the communication between the input port 25h and the output port 25g are all broken away corresponding to the left half position of the spool 25p.

The C3-B2 apply control valve 26 includes the spool 26p and a spring 26s urging the spool 26p upward in the drawing, and includes the hydraulic oil chamber 26a upward of the spool 26p in the drawing, and further includes the output port 26b, an input port 26c, an output port 26d, the input port 26e, an output port 26f, and an input port 26g in sequence from above in the drawing.

The output port S1b of the solenoid valve S1 is coupled to the hydraulic oil chamber 26a via the oil channels m1, m3. When the modulator pressure P_{MOD} output from the output port S1b is input via the oil channels m1, m3 as the signal pressure P_{S1} by the energization of the solenoid valve S1, the spool 26p stands in the right half position against an urging force of the spring 26s. In contrast, when the non-input of the signal pressure P_{S1} is made to the hydraulic oil chamber 26a due to no energization of the solenoid valve S1, the spool 26p stands in the left half position by the urging force of the spring 26s.

In the C3-B2 apply control valve 26, the input port 26c is brought into communication with the output port 26b corresponding to the right half position of the spool 26p, whereby an oil channel c1 which receives an input of the R-range pressure P_{REV} is brought into communication with the input port 27e of the B2 apply control valve 27 via an oil channel c2, the input port 26c, the output port 26b, and further the oil channels n1, n2. Also, in the same manner, the input port 26e is brought into communication with the output port 26d corresponding to the right half position of the spool 26p, whereby the output port 23d of the first clutch apply relay valve 23 is brought into communication with an input port 27c of the B2 apply control valve 27 via the oil channel g2, the input port 26e, the output port 26d, and further the oil channel p. Furthermore, in the same manner, the input port 26g is brought into communication with the output port 26f corresponding to the right half position of the spool 26p, whereby the oil channel c1 which receives the input of the R-range pressure P_{REV} is brought into communication with the hydraulic servo 33 via an oil channel c3, the input port 26g, the output port 26f, and further an oil channel g3.

In contrast, in the C3-B2 apply control valve 26, the input port 26c is brought into communication with the output port 26d corresponding to the left half position of the spool 26p, whereby the oil channel c1 which receives the input of the R-range pressure P_{REV} is brought into communication with the input port 27c of the B2 apply control valve 27 via the oil channel c2, the input port 26c, the output port 26d, and further the oil channel p. Also, in the same manner, the input port 26e is brought into communication with the output port 26f corresponding to the left half position of the spool 26p, whereby the output port 23d of the first clutch apply relay valve 23 is brought into communication with the hydraulic servo 33 via the oil channel g2, the input port 26e, the output port 26f, and further the oil channel g3. Also, the communication between the input port and the output port 26d, and the communication between the input port 26e and the output port 26f are broken away corresponding to the right half position of the aforementioned spool 26p, and the communication between the input port 26c and the output port 26b, the communication between the input port 26e and the output port 26d, and the communication between the input port 26g and the output port 26f are all broken away corresponding to the left half position of the spool 26p described above.

The B2 apply control valve 27 includes the spool 27p and a spring 27s which urges the spring 27p upward in the drawing, and includes the hydraulic oil chamber 27a upward of the spool 27p in the drawing, and the hydraulic oil chamber 27b formed by the difference in land diameter (the difference in pressure receiving surface area) of the spool 27p, and includes the input port 27c, an output port 27d, and the input port 27e in sequence from above in the drawing.

The output port 22g of the second clutch apply relay valve 22 is connected to the aforementioned hydraulic oil chamber 27a via the oil channels j1, j2, and when the modulator pressure P_{MOD} input to the input port 22f via the oil channel y1 is input via the output port 22g, the oil channels j1, j2 corresponding to the right half position of the spool 22p of the second clutch apply relay valve 22, the right half position is assumed against an urging force of the spring 27s, and when non-input is made, the left half position is assumed by the urging force of the spring 27s. The output port 25c of the second solenoid relay valve 25 is connected to the hydraulic oil chamber 27b via the oil channel e7.

In the B2 apply control valve 27, the input port 27e is brought into communication with the output port 27d corresponding to the right half position of the spool 27p, whereby the output port 26b of the C3-B2 apply control valve 26 is brought into communication with the hydraulic servo 35 via the oil channels n1, n2, the input port 27e, the output port 27d, and further the oil channel n4. In contrast, in the B2 apply control valve 27, the input port 27c is brought into communication with the output port 27d corresponding to the left half position of the spool 27p, whereby the output port 26d of the C3-B2 apply control valve 26 is brought into communication with the hydraulic servo 35 via the oil channel p, the input port 27c, the output port 27d, and further an oil channel n4. The communication between the input port 27c and the output port 27d is broken away corresponding to the right half position of the spool 27p, and, in contrast, the communication between the input port 27e and the output port 27d is broken away corresponding to the left half position of the spool 27p.

[Action of Hydraulic Control Apparatus]

Subsequently, an outline of the operation (action) of the hydraulic control apparatus 1₁ will be described. For example, when the ignition is turned ON by a driver, the hydraulic control of the hydraulic control apparatus 1₁ is started. First of all, when the selected position of the shift lever is, for example, the P range or the N range, the aforementioned four linear solenoid valves SL1, SL2, SL3, SL4 which are of the normally closed type are energized by an electric command from the control unit 50 (see FIG. 4), and the respective input ports SL1a, SL2a, SL3a, SL4a and the output ports SL1b, SL2b, SL3b, SL4b are brought into communication.

Subsequently, for example, when the engine is started, a hydraulic pressure is generated by the rotation of the oil pump (not shown) on the basis of the engine revolutions, and the hydraulic pressure is regulated and output to the line pressure P_{L} or the modulator pressure P_{MOD} respectively by the primary regulator valve or the solenoid modulator valve as described above. Then, the line pressure P_{L} is input to the linear solenoid valve SL3 via the manual valve or the like, and the modulator pressure P_{MOD} is input to the linear solenoid valve SLU and the solenoid valves S1, S2.

Subsequently, when the driver changes the shift lever, for example, from the N-range position to the D-range position, the D-range pressure P_{D} is output from the manual valve and the corresponding D-range pressure P_{D} is input to the linear solenoid valves SL1, SL2, SL4, respectively. Here, for example, when the driver increases the speed of the vehicle, the engaging pressures P_{SL1}, P_{SL2}, P_{SL3}, P_{SL4} are generated from the respective linear solenoid valves SL1, SL2, SL3, SL4, and the engaging pressures are supplied to the hydraulic servos 31-33 via the first clutch apply relay valve 23 in which the first clutch apply relay valve 23 stands in the right half position. Then, the respective clutches C-1, C-2, C-3, B-1 are engaged as indicated by a table of engagement, and so that the gear is shifted from forward first gear (1st) to forward sixth gear (6th) one after another.

Subsequently, for example, the driver reduces the speed of the vehicle, and the gear is shifted down according to the vehicle speed. Then, when the shift lever is moved from the D-range position to the N-range position after the vehicle is stopped in the state of the forward first gear, the D-range pressure P_{D} is drained from the aforementioned manual valve.

Also, when the shift lever is brought into the R-range position by the operation of the shift lever by the driver, for example, the R-range pressure P_{REV} is output from the manual valve, and the corresponding R-range pressure P_{REV} is supplied to the hydraulic servo 35 via the C3-B2 apply control valve 26 and the B2 apply control valve 27, and the brake B-2 is engaged. Furthermore, the engaging pressure P_{SL3} from the linear solenoid valve SL3 is input to the hydraulic servo 33 via the first clutch apply relay valve 23, and the C3-B2 apply control valve 26, and the clutch C-3 is engaged. Accordingly, the reverse first gear is achieved in cooperation with the engagement with the aforementioned brake B-2.

[Action at the Time of Limp Home]

In the forward first gear to the forward sixth gear, the first clutch apply relay valve 23 stands in the right half position in the normal state, and stands in the left half position at the time of fail. In other words, in the first solenoid relay valve 24, the signal pressure (engaging pressure P_{SL1}) from the linear solenoid valve SL1 is input to the hydraulic oil chamber 24a in the forward first gear to the forward fourth gear, and the signal pressure (engaging pressure P_{SL2}) from the linear solenoid valve SL2 is input to the hydraulic oil chamber 24b in the forward fourth gear to the sixth gear and hence the right half position is assumed. Therefore, the modulator pressure P_{MOD} input to the input port 24e is input to the hydraulic oil chamber 23a of the first clutch apply relay valve 23 via the output port 24d and the oil channel q.

Here, for example, when the engaging pressure rises from the linear solenoid valve SL1 in the forward first gear, the signal pressure input to the hydraulic oil chamber 24a is low, so that there is a risk of switching of the spool 24p to the left half position. If there is such a risk, it is possible to energize the solenoid valve S1, input the signal pressure P_{S1} to the hydraulic oil chamber 25a of the second solenoid relay valve 25, and switch the spool 25p to the right half position, so that the modulator pressure P_{MOD} input to the input port 25h can be input to the hydraulic oil chamber 23a of the first clutch apply relay valve 23 via the output port 25g, the oil channel r, the input port 24c, the output port 24d, and the oil channel q.

In this manner, in the forward first gear to the forward sixth gear in the normal state, the spool 23p of the first clutch apply relay valve 23 is held in the right half position (position in the normal state). When the spool 23p is in the right half position, a state in which the engaging pressures P_{SL1}, P_{SL2}, P_{SL3} from the linear solenoid valves SL1, SL2, SL3 can be supplied to the hydraulic servos 31, 32, 33, 35 via the first clutch apply relay valve 23 is assumed.

In contrast, at the time of fail, no signal pressure is input to the hydraulic oil chambers 24a, 24b of the first solenoid relay valve 24 and the hydraulic oil chamber 25a of the second solenoid relay valve 25. Therefore, in the first solenoid relay valve 24 and the second solenoid relay valve 25, the spools 24p, 25p stand in the left half position, and the signal pressure is not input to the hydraulic oil chamber 23a of the first clutch apply relay valve 23, so that the spool 23p stands in the left half position (the position at the time of fail). If the spool 23p stands at the left half position, the communication between the linear solenoid valves SL1, SL2, SL3 and the hydraulic servos 31, 32, 33, 35 is broken away, and a state in which the engaging pressure P_{SL3} from the linear solenoid valve SL3 can be supplied to the hydraulic servo 33, and the engaging pressure from the second clutch apply relay valve 22, described below, can be supplied to the hydraulic servo 31 or the hydraulic servo 32 via the first clutch apply relay valve 23 is achieved.

In contrast, in the second clutch apply relay valve 22, the spool 22p stands in the left half position in the low-speed gears (forward first gear to forward third gear) in which the signal pressure from the linear solenoid valve SL2 is not input to the hydraulic oil chamber 22a, and stands in the right half position in the high-speed gears (forward fourth gear to the forward sixth gear) in which the signal pressure is input. The spool 22p maintains its position as-is at the time of fail. In other words, when the fail occurs in the low-speed gears, the spool 22p maintains its position in the left half position, and when the fail occurs in the high-speed gears, the modulator pressure P_{MOD} input to the input port 22f is input to the hydraulic oil chamber 22b to lock the spool 22p, so that the spool 22p maintains its position in the right half position.

When the fail occurs during the travel of the vehicle, the forward third speed is achieved if the traveling gear at this time is the low-speed gears, and the forward fifth gear is achieved if it is the high-speed gears. In other words, since the spools 22p, 23p of the second clutch apply relay valve 22 and the first clutch apply relay valve 23 both stand in the left half position in the low-speed gears, the D-range pressure P_{D} input to the second clutch apply relay valve 22 via the oil channels b1, b2 is supplied to the hydraulic servo 31 of the clutch C-1 via the oil channel k, the first clutch apply relay valve 23, and the oil channel e6.

In contrast, since the spool 22p of the second clutch apply relay valve 22 stands in the right half position and the spool 23p of the first clutch apply relay valve 23 stands in the left half position in the high-speed gears, the D-range pressure P_{D} input to the second clutch apply relay valve 22 via the oil channels b1, b3 is supplied to the hydraulic servo 32 of the clutch C-2 via the oil channel i, the first clutch apply relay valve 23, and the oil channel f5. Since the spool 23p of the first clutch apply relay valve 23 stands in the left half position, the line pressure P_{L} is supplied to the hydraulic servo 33 of the clutch C-3 via the oil channel a2, the first clutch apply relay valve 23, the oil channel g2, the C3-B2 apply control valve 26 (spool 26p stands in the left half position), and the oil channel g3 both in the low-speed gears and the high-speed gears.

In this manner, when the fail occurs during the travel of the vehicle in the low-speed gears, the engaging pressure is supplied to the hydraulic servos 31, 33 to engage the clutches C-1, C-3, and as shown in the table of engagement in FIG. 2, the forward third gear is achieved. In contrast, when the fail occurs during the travel in the high-speed gears, the engaging pressure is supplied to the hydraulic servos 32, 33 to engage the clutches C-2, C-3, and as shown in the table of engagement in FIG. 2, the forward fifth gear is achieved. Therefore, even when the fail occurs during the travel in any gears from the forward first gear to the forward sixth gear, the travel can be continued without causing any transmission shock.

Then, when the vehicle is stopped and the ignition is turned OFF, even when the fail occurs in the high-speed gears, the D-range pressure P_{D} which is supplied to the hydraulic oil chamber 22b of the second clutch apply relay valve 22 and locks the spool 22p to the right half position is not generated any longer, and hence the spool 22p is switched to the left half position by the urging force of the spring, whereby the clutches C-1, C-3 are engaged in the same manner as when the fail occurs in the low-speed gears, so that the forward third gear is achieved.

Accordingly, when the ignition is turned ON the re-acceleration from the forward third gear is also possible, and so-called the limp home function is achieved.

[Action at the Time of Reverse Inhibit]

Also, for example, if the vehicle speed is detected to be not lower than the predetermined speed in the forward direction when the shift lever is operated to the R-range position by the driver, the solenoid valve S2 is energized by the control unit 50 (see FIG. 4), and the energized state of the linear solenoid valve SLC3 is blocked, that is, the R-range pressure P_{REV} is blocked so as not to be supplied to the hydraulic servo 35 of the brake B-2 by the B2 apply control valve 27, and the engaging pressure is not supplied to the hydraulic servo 33 of the clutch C-3, whereby achievement of the reverse first gear is prevented, that is, so-called a reverse-inhibit function is achieved.

[Detailed Configuration of Hydraulic Control Apparatus of Lockup Clutch]

The hydraulic control apparatus 2 of the lockup clutch includes the aforementioned solenoid valve S2 as a second signal pressure output unit, the linear solenoid valve SLU as a first signal output unit, the lockup relay valve (switching device) 28, the lockup control valve 29, the determination means 60, the evaluation means 52, the control means 51, and so on described later in detail with reference to FIG. 4.

The lockup clutch 7 is a single disk type having one clutch disk, and includes an engaging-side oil chamber 4e which causes the engagement of the lockup clutch 7 by an oil pressure (engaging oil pressure) supplied via oil channels u1 (first oil channel), u2 (first oil channel), described later, on one side, and a releasing-side oil chamber 4f configured to release the lockup clutch 7 by a hydraulic pressure (releasing hydraulic pressure) supplied via oil channels v2 (second oil channel), v3 (second oil channel), and the like, described later, on the other side.

The linear solenoid valve SLU is a valve of a normally closed type, and brings the input port SLUa and an output port SLUb into communication when being energized to regulate the modulator pressure P_{MOD} input to the input port SLUa according to the amount of energization and output as the signal pressure P_{SLU} from the output port SLUb, and assumes the non-output state when not being energized.

The lockup relay valve 28 includes a spool 28p and a spring 28s which urges the spool 28p upward in the drawing, and includes a hydraulic oil chamber 28a upward of the spool 28p in the drawing, and the hydraulic oil chamber 28i downward of the spool 28p in the drawing, and further includes an input port 28b, an output port 28c, an output port 28d, an input port 28e, an input port 28f, an output port 28g, and the input port 28h in sequence from above in the drawing.

The output port SLUb of the aforementioned linear solenoid valve SLU is connected to the hydraulic oil chamber 28a via oil channels s1, s2, and an orifice 45. When the modulator pressure P_{MOD} output from the output port SLUb is input to the hydraulic oil chamber 28a as the signal pressure P_{SLU} by the energization of the aforementioned linear solenoid valve SLU, the spool 28p stands in the right half position against an urging force of the spring 28s and, in contrast, stands in the left half position by the urging force of the spring 28s by non-input of the above-described signal pressure P_{SLU}. The output port S2b of the solenoid valve S2 is connected to the hydraulic oil chamber 28i via the oil channels 11, 12, the second solenoid relay valve 25, the oil channel 14, and the orifice 47. The signal pressure P_{SL2} output from the solenoid valve S2 is input to the hydraulic oil chamber 28i via the second solenoid relay valve 25 or the like when the solenoid valve S2 is in the energized state and the second solenoid relay valve 25 stands in the right half position, that is, only when the solenoid valve S1 is in the energized state.

In the lockup relay valve 28, the input port 28b is brought into communication with the output port 28c corresponding to the right half position of the spool 28p, whereby an oil channel x1 which receives an input of the secondary pressure P_{SEC} is brought into communication with the oil cooler 36 via the input port 28b, the output port 28c, an oil channel t, and an orifice 40. Also, in the same manner, the input port 28e is brought into communication with the output port 28d corresponding to the right half position of the spool 28p, whereby an oil channel x2 which receives the input of modulator pressure P_{MOD} is brought into communication with an input port 4c on the ON side of the lockup clutch 7 via the input port 28e, the output port 28d, and further oil channels u1, u2 and an orifice 48, and is also brought into communication with the hydraulic oil chamber 29a of the lockup control valve 29 via an oil channel u3 branched from the oil channel u1 and an orifice 46.

Furthermore, in the same manner, the input port 28h is brought into communication with the output port 28g corresponding to the right half position of the spool 28p, whereby an output port 29d of the lockup control valve 29 is brought into communication with the input port 4d on the OFF side of the lockup clutch 7 via an oil channel v1, the input port 28h, the output port 28g, and further the oil channels v2, v3 and an orifice 49. When the spool 28p is switched to the left half position, the above-described communication, that is, the communication between an input port 28b and the output port 28c, the communication between the input port 28e and the output port 28d, and the communication between the input port 28h and the output port 28g are all broken away.

In contrast, in the lockup relay valve 28, the input port 28f is brought into communication with the output port 28g corresponding to the left half position of the spool 28p, whereby an oil channel x3 which receives the input of the secondary pressure P_{SEC} is brought into communication with the input port 4d on the OFF side of the lockup clutch 7 via the input port 28f, the output port 28g, and further oil channels v2, v3 and the orifice 49, and is brought into communication with a hydraulic oil chamber 29f of the lockup control valve 29 via an oil channel v4 branched from the oil channel v2 and an orifice 57. When the spool 28p is switched to the right half position, the communication between the input port 28f and the output port 28g as described above is broken away.

The lockup control valve 29 includes a spool 29p and a spring 29s which urges the spool 29p rightward in the drawing, and also includes the hydraulic oil chamber 29a upward of the spool 29p in the drawing, the hydraulic oil chamber 29f downward of the spool 29p in the drawing, a hydraulic oil chamber 29b formed by the difference in land diameter (the difference in pressure receiving surface area) of the spool 29p, and includes a drain port 29c, the output port 29d, and an input port 29e in sequence from above in the drawing.

The output port 28d of the aforementioned lockup relay valve 28 is connected to the hydraulic oil chamber 29a via the oil channel u3 or the like, and the output port SLUb of the linear solenoid valve SLU is connected to the hydraulic oil chamber 29b via the oil channels s1, s2, and an orifice 41, and further the output port 28g of the lockup relay valve 28 is connected to the oil chamber 29f via the oil channel v4 or the like.

In the lockup control valve 29, when the linear solenoid valve SLU is energized and the signal pressure P_{SLU} output from the output port SLUb is input to the hydraulic oil chamber 29b via the oil channel s1 or the like, the spool 29p stands in the right half position against an urging force of the spring 29s, and stands in the left half position by the no input of the signal pressure P_{SLU}.

In the lockup control valve 29, the amount of opening of the drain port EX of the hydraulic oil chamber 29a becomes minimum and the output port 29d is brought into communication with the drain port 29c corresponding to the right half position of the spool 29p. When the spool 29p is switched to the left half position, the communication between the output port 29d and the drain port 29c is broken away.

In contrast, in the lockup control valve 29, the input port 29e and the output port 29d are brought into communication corresponding to the left half position of the spool 29p, whereby an oil channel x4 which receives the input of the modulator pressure P_{MOD} is brought into communication with the input port 28h of the lockup relay valve 28 via the input port 29e, the output port 29d, and further the oil channel v1. This communication is broken away when the spool 29p is switched to the right half position.

[Action of Hydraulic Control Apparatus of Lockup Clutch]

In the hydraulic control apparatus 2 of the lockup clutch, when the linear solenoid valve SLU is turned ON (energized), the signal pressure P_{SLU} output from the linear solenoid valve SLU is input to the hydraulic oil chambers 28a, 29a of the lockup relay valve 28 and the lockup control valve 29, respectively, and the respective spools 28p, 29p are switched to the right half positions.

Correspondingly, the secondary pressure P_{SEC} input to the input port 28b of the lockup relay valve 28 is supplied to the oil cooler 36 or the like via the oil channel t or the like. Also, the modulator pressure P_{MOD} input to the input port 28e is supplied to the engaging-side oil chamber 4e of the lockup clutch 7 via the oil channel u1 or the like. Then, the input port 28h and the output port 28g are brought into communication with each other, whereby the hydraulic pressure in the releasing-side oil chamber 4f is discharged from the drain port 29c of the lockup control valve 29 via the oil channels v3, v4, v1, and the like.

Accordingly, the hydraulic pressure in the engaging-side oil chamber 4e becomes higher than the hydraulic pressure in the releasing-side oil chamber 4f, and the lockup clutch 7 is engaged on the basis of the pressure difference therebetween. In this state, part of the modulator pressure P_{MOD} input to the input port 28e is discharged little by little from the drain port EX via the oil channel u3 branched from the oil channel u1 and the hydraulic oil chamber 29a of the lockup control valve 29. In other words, by supplying the modulator pressure P_{MOD} to the engaging-side oil chamber 4e while discharging part of it, the engaging pressure is generated in the engaging-side oil chamber 4e, whereby the engaging state of the lockup clutch 7 is maintained.

When the linear solenoid valve SLU is turned OFF (not energized) from this state, in the lockup relay valve 28 and the lockup control valve 29, the signal pressure P_{SLU} is not input to the respective hydraulic oil chambers 28a, 29a and hence the respective spools 28p, 29p are switched to the left half position.

Correspondingly, in the lockup relay valve 28, the secondary pressure P_{SEC} and the modulator pressure P_{MOD} which are input respectively to the input port 28b and the input port 28e are stopped. Therefore, supply of the hydraulic pressure to the oil cooler 36 and the engaging-side oil chamber 4e is stopped and the hydraulic pressure staying in the engaging-side oil chamber 4e is discharged from the drain port EX via the oil channel u3, the hydraulic oil chamber 29a of the lockup control valve 29, and the like. Also, in the same manner, the input port 28f is brought into communication with the output port 28g corresponding to the left half position of the spool 28p of the lockup relay valve 28, whereby the secondary pressure P_{SEC} input to the input port 28f via the oil channel x3 is supplied to the releasing-side oil chamber 4f via the oil channels v2, v3, and the like.

Accordingly, the hydraulic pressure in the releasing-side oil chamber 4f becomes higher than the hydraulic pressure in the engaging-side oil chamber 4e, and the lockup clutch 7 is released on the basis of the pressure difference therebetween. Part of the secondary pressure P_{SEC} input to the input port 28f is input to the hydraulic oil chamber 29f of the lockup control valve 29 via the oil channel v4 branched from the oil channel v2 or the like, and urges the spool 29p toward the right half position.

As described above, in the lockup relay valve 28, the switching from the left half position (position on the releasing side) and the right half position (position on the engaging side) of the spool 28p is achieved by the input of the signal pressure P_{SLU} of the linear solenoid valve SLU to the hydraulic oil chamber 28a. Therefore, generally, response is higher than the case where the switching is achieved by the spring force (urging force) of the spring. In contrast, reverse switching from the right half position (position on the engaging side) to the left half position (position on the releasing side) depends on the spring force of the spring 28s, and hence the response thereof may not be necessarily enough. Then, when the response is not enough, so-called disconnection of the lockup clutch 7 is not done at a right moment, so that feeling of discomfort may remain in the operation feeling as described above.

Accordingly, in this embodiment, if the insufficient response may occur in the state of the vehicle (the operating state, the traveling state, etc.), the hydraulic pressure is supplied to the hydraulic oil chamber 28i of the lockup relay valve 28 so as to assist to urge the spool 28p in the same direction as the urging direction by the spring 28s. In other words, firstly, the state of the vehicle is determined by the determination means 60 (see FIG. 4). Here, the determination means 60 includes a means for estimating or calculating on the basis of the information from the various sensors 61-66 or the like in addition to the means 67 (the various sensors 61-66) for detecting the state of the vehicle. Subsequently, on the basis of the result of determination, the evaluation means 52 evaluates whether the assist by the hydraulic pressure is needed or not. If it is evaluated to be needed, an instruction is issued from the control means 51 to output signal pressure (second signal pressure P_{S2}) to the hydraulic oil chamber 28i of the lockup relay valve 28 to the solenoid valve S2 as the second signal pressure output unit. Detailed description will be given below.

As shown in FIG. 4, in addition to the lockup relay valve 28 described above, the hydraulic control apparatus 2 of the lockup clutch 7 includes various sensors such as an engine revolution sensor 61 configured to detect the number or revolutions of an output shaft of the engine, a vehicle speed sensor 62 configured to detect the number of revolutions of an output shaft of the automatic transmission 3, a depressing pressure sensor (means for detecting information relating to a sudden stop) 63 configured to detect the depressing pressure of the brake, a wheel speed sensor (means for detecting the information relating to the sudden stop) 64 configured to detect the numbers of revolutions of a plurality of wheels respectively, a converter revolution sensor 65 configured to detect the numbers of revolutions of the pump impeller 4a and the turbine runner 4b of the torque converter 4, respectively, an acceleration sensor (G sensor) 66, and a means for estimating or calculating on the basis of the information from these sensors 61-66 as the determination means 60 configured to determine the state of the vehicle.

In contrast, the control unit (ECU) 50 which controls the hydraulic control apparatus 2 of the lockup clutch includes the control means 51, the evaluation means 52, part of the determination means 60, a range detection means 53, an automatic transmission means 54 configured to change the speed according to a map 55, a timer means 56, and so on. The evaluation means 52 among them evaluates whether the result of determination by the above-described determination means 60, that is, the results of detection that the various sensors 61-65 detect or the results of estimation or calculation on the basis of the information is not smaller than a predetermined value (or not larger than the predetermined value) or not and, on the basis of the result of evaluation, the control means 51 turns ON (energize) the solenoid valve S2 or the like to supply the signal pressure P_{S2} to the hydraulic oil chamber 28i of the lockup relay valve 28.

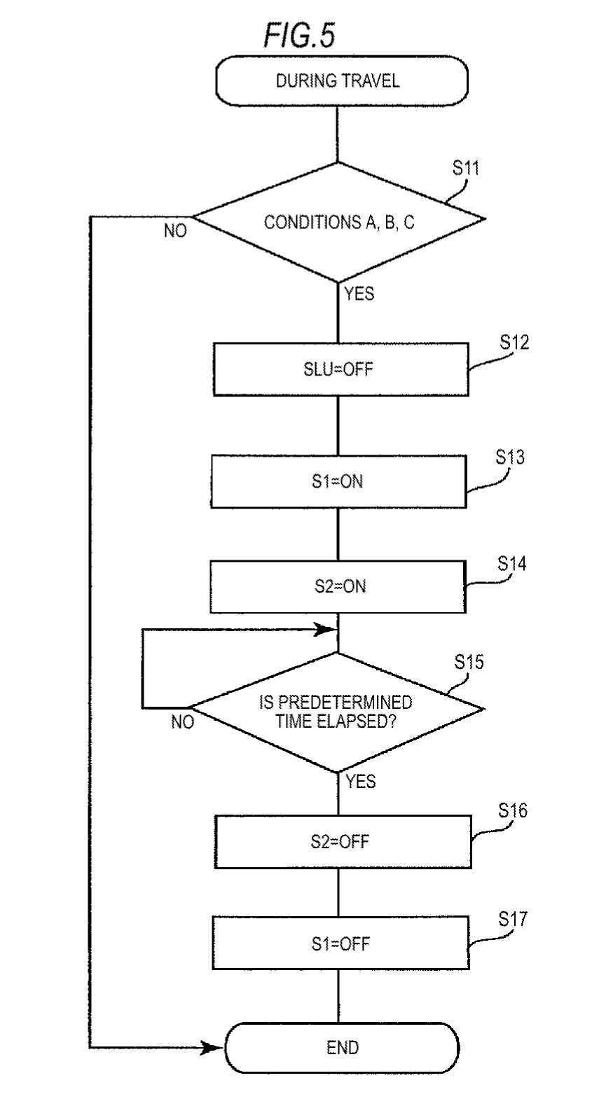

In other words, for example, as shown in a flowchart in FIG. 5, in a state of during the travel of the vehicle and the lockup clutch 7 is engaged, whether one of a condition A, a condition B, and a condition C is satisfied or not is evaluated by the evaluation means 52 (Step S11). Here, the condition A is that the number of revolutions of the output shaft of the engine detected by the engine revolution sensor 61 is not larger than a predetermined value, the condition B is that the number of revolutions of the output shaft of the automatic transmission 3 detected by the vehicle speed sensor 62 is not larger than a predetermined value, and the condition C is that the signal pressure is not output from the linear solenoid valve SLU to the lockup relay valve 28 and the difference between the number of revolutions of the pump impeller 4a and the number of revolutions of the turbine runner 4b detected by the converter revolution sensor 65 is not larger than a predetermined value.

If the last condition C is satisfied, the evaluation means 52 determines that a failure occurs in a hydraulic circuit. In other words, since the difference in number of revolutions between the pump impeller 4a and the turbine runner 4b is not increased irrespective of the fact that the lockup clutch 7 is released, the linear solenoid valve SLU is determined to have a failure, and the lockup relay valve 28 is forcedly switched. In other words, when the difference in number of revolutions between the pump impeller 4a and the turbine runner 4b is evaluated to be not larger than the predetermined value, the signal pressure control means 59 is caused to output the signal pressure P_{SLU} from the linear solenoid valve SLU to switch the lockup relay valve 28 to the released position.

When the evaluation means 52 evaluates that any of the conditions A, B, C is not satisfied (“NO” in Step S11), the control is immediately terminated. In contrast, if it is evaluated that one of the conditions A, B, and C is satisfied (“YES” in Step S11), the linear solenoid valve SLU shown in FIG. 3 is turned OFF by the control means 51 (Step S12), the solenoid valve S1 is turned ON (Step S13), and the solenoid valve S2 is turned ON (Step S14). Accordingly, since the signal pressure PS1 of the solenoid valve S1 is input to the hydraulic oil chamber 25a of the second solenoid relay valve 25 and the spool 25p is switched to the right half position, the signal pressure P_{S2} of the solenoid valve S2 is supplied to the hydraulic oil chamber 28i of the lockup relay valve 28 via the oil channels 11, 12, the second solenoid relay valve 25, and the oil channel 14. Therefore, the spool 28p of the lockup relay valve 28 in the right half position (position on the engaging side) is urged toward the left half position (the position on the releasing side) by a spring force of a spring S and, in addition, is also urged in the same direction (the urging direction of the sprint S) by the signal pressure P_{S2} supplied to the hydraulic oil chamber 28i. In other words, the response of the spool 28p is improved and hence it can be switched from the right half position (the position on the engaging side) to the left half position (the position on the releasing side) in a short time in comparison with the case of being urged only by the spring 28s.

Subsequently, when the time counted by the timer means 56 has elapsed a predetermined time from when the solenoid valve S2 is turned ON (“YES” in Step S15), the control means 52 turns the solenoid valve S2 OFF (Step S16), turns the solenoid valve S1 OFF (Step S17), and then terminates the control of the lockup relay valve 28, so that the normal control of the lockup clutch 7 by the linear solenoid valve SLU is restored. In the description given above, the conditions A, B, C in Step S11 are described as OR conditions. Alternatively, two of them may be used as AND condition, or all the three may be used as AND condition. However, when the condition C described above is satisfied, the hydraulic circuit may have a failure. Therefore, a suitable procedure should be taken such as releasing the lockup clutch 7 quickly by the control described above, and stopping the vehicle immediately.

In the condition C described above, as a method of determination of the difference in number of revolutions between the pump impeller 4a and the turbine runner 4b of the torque converter 4, for example, a determination from the difference between the number of engine revolutions and the number of revolutions of the input shaft 10 of the automatic transmission mechanism 5 (see FIG. 1) is also applicable instead of using the above-described converter revolution sensor 65. Here, the number of revolutions of the input shaft 10 of the automatic transmission mechanism 5 can be calculated from the vehicle speed detected by the vehicle speed sensor 62 or the number of revolutions of the wheel detected from the wheel speed sensor 66.

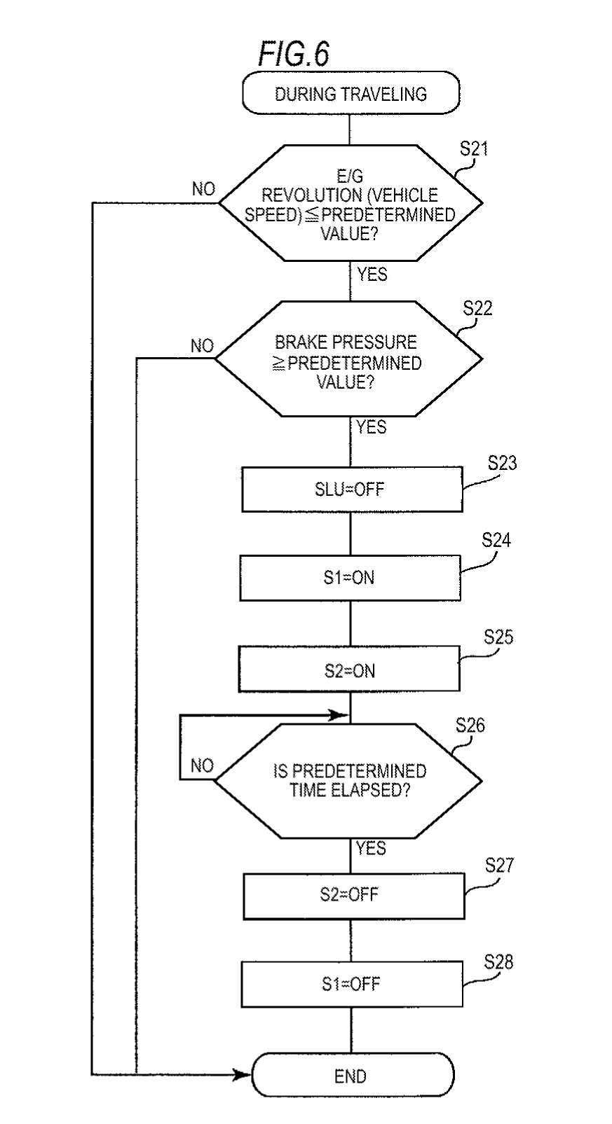

Referring now to FIG. 6, an example of detecting the state of vehicle on the basis of the engine revolution sensor 61 and the depressing pressure sensor 63 will be described. In the same manner as described above, in the state in which the vehicle is traveling and the lockup clutch 7 is engaged, in Step S21, the evaluation means 52 evaluates whether the depressing pressure of the brake detected by the depressing pressure sensor 63 is to lower than the predetermined value or not only when the number of engine revolutions detected by the engine revolution sensor 61 is not larger than the predetermined value (“YES” in Step S21) (Step S22). If it is smaller than the predetermined value (“NO” in Step S22), the control is immediately terminated. In contrast, if the evaluation means 52 evaluates the value is not smaller than the predetermined value (“YES” in Step S22), that is, when it is determined to be the sudden stop, the control means 51 turns the linear solenoid valve SLU OFF (Step S23), turns the solenoid valve S1 ON (Step S24), and turns the solenoid valve S20N (Step S25). Since the procedure from Step S23 to Step S28 is the same as the procedure from Step S12 to Step S17 in FIG. 5 described above, description will be omitted. In Step S21, the evaluation means 52 is able to evaluate the information from the engine revolution sensor 61 instead of evaluating the information from the vehicle speed sensor 62.

In the description given above, the depressing pressure of the brake is detected using the depressing pressure sensor 63 for evaluating the sudden stop of the vehicle. However, the evaluation of the sudden stop may be made on the basis of whether the brake is depressed or not instead. For example, whether the brake is depressed or not can be determined from the signal which illuminates a brake lamp of the vehicle, or can be determined from the brake pressure which engages the brake of the vehicle. In addition, the sudden stop of the vehicle can be determined, for example, from the period from the release of the accelerator to the depression of the brake, the accelerator releasing speed and the brake depressing speed, or the deceleration of the vehicle when the brake is depressed.

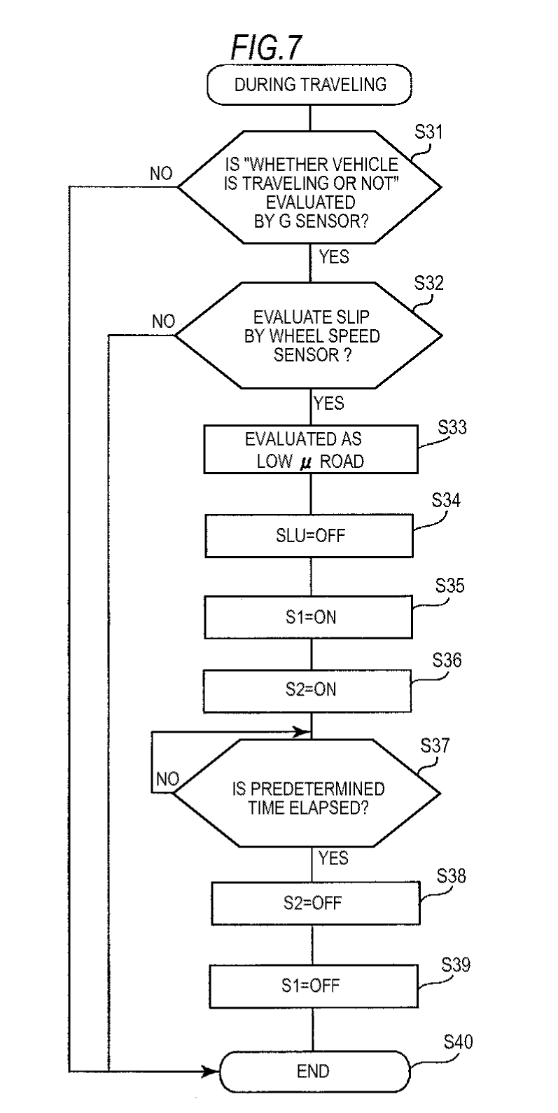

Referring now to FIG. 7, an example of detecting the state of the vehicle using the wheel speed sensor (G sensor) 66 and the wheel speed sensor 64 will be described. In other words, whether the road surface where the vehicle is traveling is a low-friction road surface (low μ road) or not is evaluated by detecting the numbers of revolutions of the four wheels using the wheel speed sensor 64. In the same manner as the description given above, in the state in which the vehicle is traveling and the lockup clutch 7 is engaged, the evaluation means 52 determines whether the vehicle is traveling or not on the basis of the result of detection of the wheel speed sensor 66 (Step S31). When it is determined to be traveling (“YES” in Step S31), then the slip evaluation is performed on the basis of the result of detection of the wheel speed sensor 64. For example, the numbers of revolutions of the four wheels of the vehicle are individually detected, and whether the difference in number of revolutions between the number of revolutions of the wheel whose number of revolutions is the smallest and the number of revolutions of the wheel whose second smallest number of revolutions is not smaller than the predetermined value or not is evaluated by the wheel speed sensor 64 (Step S32). Here, when it is evaluated not to be smaller than the predetermined value, the road surface on which the vehicle is traveling is evaluated to be a road surface having a small coefficient of friction (low μ road) such as snowy roads (Step S33). On the basis of the evaluation of the evaluation means 52, the control means 51 turns the linear solenoid valve SLU OFF (Step S34), turns the solenoid valve S1 ON (Step S35), and turns the solenoid valve S2 ON (Step S36). Since the procedure from Step S34 to Step S39 is the same as the procedure from Step S12 to Step S17 in FIG. 5 described above, description will be omitted. In the description given above, a case of evaluating whether the difference in number of revolutions between the number of revolutions of the wheel whose number of revolutions are the smallest and the number of revolutions of the wheel whose second smallest number of revolutions is not smaller than the predetermined value or not has been described. However, it is also possible to evaluate, for example, by calculating the average of the numbers of revolutions of the four wheels and evaluating whether the difference in number of revolutions between the average value and the number of revolutions of the wheel whose number of revolutions is the smallest is not smaller than the predetermined value or not instead.

In the description described above, an example in which the solenoid valves S1, S2 and the second solenoid relay valve 25 are used has been described as a configuration for outputting the signal pressure to the hydraulic oil chamber 28i of the lockup relay valve 28. All these valves are provided for achieving other functions described above, and are not specifically for outputting the signal pressure to the hydraulic oil chamber 28i. Therefore, the number of components can be reduced and hence the configuration can be simplified in comparison with the case where the specific members are provided. Also, the signal pressure P_{S2} to be supplied to the hydraulic oil chamber 28i of the lockup relay valve 28 is generated by turning ON (energizing) the solenoid valve S2, and a configuration in which the generated signal pressure P_{S2} is stopped once by the second solenoid relay valve 25, and the second solenoid relay valve 25 is switched to the right half position by turning ON (energizing) the solenoid valve S1, whereby the signal pressure P_{S2} stopped once is supplied to the hydraulic oil chamber 28i via the oil channel 14 is employed. Therefore, when it is estimated in advance that a high response of the spool 28p of the lockup relay valve 28 is required from the above-described various sensors 61-66 or the like, the solenoid valve S2 is turned ON in advance to output the signal pressure P_{S2} and stop the same once at the second solenoid relay valve 25 and, when the evaluation means 52 described above evaluates that the results of detection of the above-described various sensors 61-66 are not smaller than the predetermined value (or not larger than the predetermined value) thereafter, the solenoid valve S1 is turned ON and the signal pressure P_{S2} stopped at the second solenoid relay valve 25 once can be supplied to the hydraulic oil chamber 28i via the oil channel 14. Accordingly, the length of the oil channel until the signal pressure P_{S2} reaches the hydraulic oil chamber 28i is reduced, so that the response of the spool 28p can further be improved. For example, in the example shown in FIG. 3, the oil channels 11, 12, 14 are necessary from the solenoid valve S2 to the hydraulic oil chamber 28i, while the lengths of the oil channels I1, I2 can substantially omitted and only the length of the oil channel 14 is used by stopping once at the second solenoid relay valve 25. It is specifically effective because the resistance in the flow channels is increased when the actual oil channel from the solenoid valve S2 to the second solenoid relay valve 25 is complex and long for example.

The reason why the solenoid valves S1, S2 and the second solenoid relay valve 25 can be diversely used for supplying the signal pressure to the hydraulic oil chamber 28i of the lockup relay valve 28 as described above is because the timing of usage thereof is different from the timings of usage thereof when being used for the original purposes. It is also possible to provide a specific solenoid valve instead of diversely using the solenoid valves S1, S2 and the second solenoid relay valve 25.

### Second Embodiment

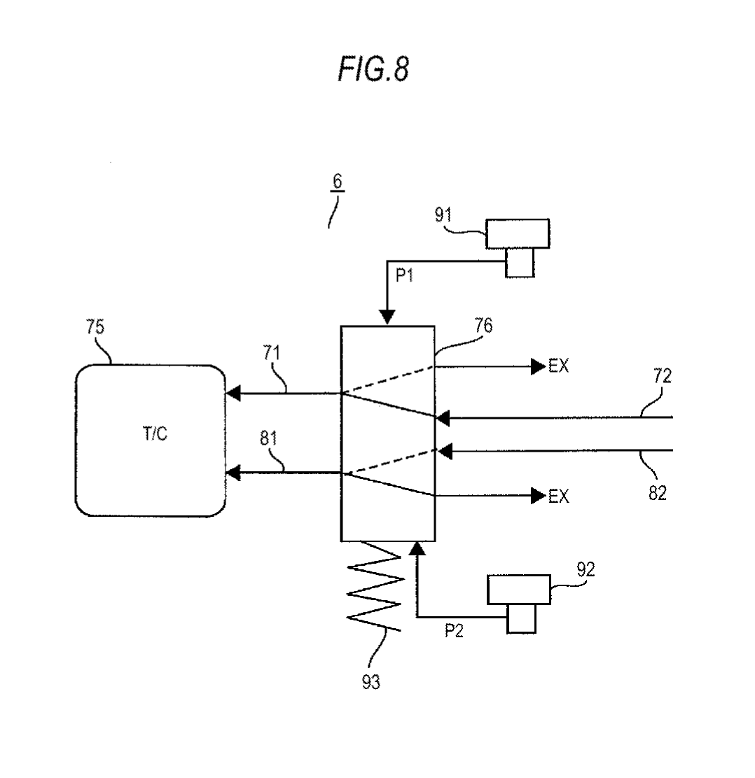

FIG. 8 shows a hydraulic control apparatus 6 for the lockup clutch according to a second embodiment.

A torque converter 75 as the fluid transmitting apparatus shown in the same drawing includes a pump impeller, a turbine runner, and a lockup clutch for engaging and disengaging these members, and further includes an engaging-side oil chamber which receives a supply of the engaging hydraulic pressure for engaging the lockup clutch and the releasing side hydraulic chamber for receiving a supply of the releasing hydraulic pressure for releasing the lockup clutch, although none of these are shown in the drawing.

A first engaging hydraulic pressure supply oil channel (first oil channel) 71 which is capable of supplying the engaging hydraulic pressure to the aforementioned engaging-side oil chamber and, separately therefrom, a first releasing hydraulic pressure supply oil channel (second oil channel) 81 which is capable of supplying the releasing hydraulic pressure to the aforementioned releasing-side oil chamber connected The torque converter 75. The first engaging hydraulic pressure supply oil channel 71 and the first releasing hydraulic pressure supply oil channel 81 are connected to a switching device 76, and a second engaging hydraulic pressure supply oil channel 72 and a second releasing hydraulic pressure supply oil channel 82 are connected to the switching device 76.

The switching device 76 is urged toward the position on the engaging side by an urging member 93 and, when it is at the position on the engaging side, brings the second engaging hydraulic pressure supply oil channel 72 and the first engaging hydraulic pressure supply oil channel 71 into communication. When the first signal pressure P1 is output from a first signal pressure output unit 91, the switching device 76 is switched to the position on the releasing side against an urging force of the urging member 93 and, when it is in the releasing position, brings the second releasing hydraulic pressure supply oil channel 82 and the first releasing hydraulic pressure supply oil channel 81 into communication. Furthermore, when the second signal pressure P2 is output from a second signal pressure output unit 92, the switching device 76 is urged in the same direction as the urging direction by the urging member 93 by the second signal pressure P2.

In the hydraulic pressure control apparatus 6 in the configuration as described above, when the switching device 76 is switched to the position on the engaging side against the urging force of the urging member 93 by the input of the first signal pressure P1, the engaging hydraulic pressure is supplied to the engaging-side oil chamber of the torque converter 75 via the second engaging hydraulic pressure supply oil channel 72 and the first engaging hydraulic pressure supply oil channel 71, and the releasing hydraulic pressure in the releasing-side oil chamber is discharged via the first releasing hydraulic pressure supply oil channel 81 and the switching device 76. Accordingly, the lockup clutch is engaged.

In contrast, when the switching device 76 is switched to the position on the releasing side by the urging force of the urging member 93 by non-input of the first signal pressure P1, the releasing hydraulic pressure is supplied to the releasing-side oil chamber of the torque converter 75 via the second releasing hydraulic pressure supply oil channel 82 and the first releasing hydraulic pressure supply oil channel 81, and the engaging hydraulic pressure in the engaging-side oil chamber is discharged via the first engaging hydraulic pressure supply oil channel 71 and the switching device 76. Accordingly, the lockup clutch is released.

Here, the switching device 76 performs the switching from the position on the releasing side to the position on the engaging side is performed by the first signal pressure P1, response is relatively (in comparison with that by the urging member 93) high. In contrast, since the reverse switching from the position on the engaging side to the position on the releasing side is performed by the urging force of the urging member 93, the response is lower than the case of being switched by the signal pressure.

Therefore, when enhancement of the response is needed when switching from the position on the engaging side to the position on the releasing side, the second signal pressure P2 is output from the second signal pressure output unit 92 to assist the urging of the switching device 76 in the same direction as the urging direction by the urging member 93. Accordingly, the response is enhanced.

The second engaging hydraulic pressure supply oil channel 72 and the second releasing hydraulic pressure supply oil channel 82 can be configured as the common oil channel.

In the above-described first embodiment and the second embodiment, a case where the fluid transmitting apparatuses are the torque converters 4, 75 has been described. However, the fluid transmitting apparatus may be, for example, a fluid coupling instead.

The hydraulic pressure control apparatus for the lockup clutch according to the present invention can be used as a hydraulic pressure control apparatus for the lockup clutch of the automatic transmission mounted on a passenger car, a truck, and so on and, specifically, is suitable to be used in the hydraulic pressure control apparatus of the lockup clutch which requires reduction of the feeling of discomfort in the operating feeling by improving the response of switching from the engaging side to the releasing side of the lockup clutch.

What is claimed is:

1. A hydraulic pressure control apparatus for a lockup clutch configured to engage and disengage the lockup clutch by controlling a pressure difference between an engaging-side oil chamber and a releasing-side oil chamber of the lockup clutch of a fluid transmission device, comprising:
a first oil channel configured to supply a hydraulic pressure to the engaging-side oil chamber of the lockup clutch;
a second oil channel configured to supply a hydraulic pressure to the releasing-side oil chamber of the lockup clutch;
a switching device configured to be capable of switching between a position on the engaging side where the supplied hydraulic pressure is output to the first oil channel, and a position on the releasing side where the supplied hydraulic pressure is output to the second oil channel;
an urging member configured to urge the switching device toward the position on the releasing side;
a first signal pressure output unit configured to be capable of outputting a first signal pressure for switching the switching device to the position on the engaging side against an urging force of the urging member; and
a second signal pressure output unit configured to be capable of outputting a second signal pressure for urging the switching device in the same direction as the urging direction of the urging member.

2. The hydraulic pressure control apparatus for a lockup clutch according to claim 1, comprising:
a determination means configured to determine the state of a vehicle on which the fluid transmission device is mounted;
an evaluation means configured to evaluate whether an output of the second signal pressure is required or not on the basis of the result of determination by the determination means; and
a control means configured to instruct an issue of the second signal pressure to the second signal pressure output unit on the basis of the result of evaluation by the evaluation means.

3. The hydraulic pressure control apparatus for a lockup clutch according to claim 2, wherein the determination means is a means for determining the number of engine revolutions of the vehicle,
the evaluation means is a means for evaluating whether the number of engine revolutions determined by the determination means is not larger than a predetermined value or not, and
the control means instructs the issue of the second signal pressure to the second signal pressure output unit when the evaluation means evaluates the number of engine revolutions not to be larger than the predetermined value.

4. The hydraulic pressure control apparatus for a lockup clutch according to claim 2, wherein the determination means is a means for determining the vehicle speed of the vehicle,
the evaluation means is a means for evaluating whether the vehicle speed determined by the determination means is not larger than a predetermined value or not, and
the control means instructs the issue of the second signal pressure to the second signal pressure output unit when the evaluation means evaluates that the vehicle speed not to be larger than the predetermined value.

5. The hydraulic pressure control apparatus for a lockup clutch according to claim 2, wherein the determination means is a means for determining information relating to a sudden stop of the vehicle,
the evaluation means is a means for evaluating whether the information determined by the determination means corresponds to the sudden stop of the vehicle or not, and
the control means instructs the issue of the second signal pressure to the second signal pressure output unit when the evaluation means evaluates the sudden stop of the vehicle.

6. The hydraulic pressure control apparatus for a lockup clutch according to claim 2, wherein the determination means is a means for determining information relating to a low-friction road surface,
the evaluation means is a means for evaluating whether the information determined by the determination means corresponds to the low-friction road surface or not, and
the control means instructs the issue of the second signal pressure to the second signal pressure output unit when the evaluation means evaluates the low-friction road surface.

7. The hydraulic pressure control apparatus for a lockup clutch according to claim 2, wherein the determination means is a means for determining depression of a brake of the vehicle,
the evaluation means is a means for evaluating whether the determination means determines that the brake is depressed or not, and
the control means instructs the issue of the second signal pressure to the second signal pressure output unit when the evaluation means evaluates the depression of the brake.

8. The hydraulic pressure control apparatus for a lockup clutch according to claim 2, wherein the fluid transmitting apparatus is a torque converter,
the determination means is a means for determining the difference in number of revolutions between a pump impeller and a turbine runner of the torque converter,
the evaluation means evaluates whether the difference in number of revolutions between the pump impeller and the turbine runner determined by the determination means is not larger than a predetermined value,
a signal pressure control means configured to instruct the issue of the first signal pressure to the first signal pressure output unit is provided; and
the control means instructs the issue of the second signal pressure to the second signal pressure output unit when the evaluation means evaluates the difference in the number of revolutions not to be larger than the predetermined value in a state in which the issue of the first signal pressure is not instructed by the signal pressure control means.

9. The hydraulic pressure control apparatus for a lockup clutch according to claim 6, wherein the determination means is a means for determining depression of a brake of the vehicle,
the evaluation means is a means for evaluating whether the determination means determines that the brake is depressed or not, and
the control means instructs the issue of the second signal pressure to the second signal pressure output unit when the evaluation means evaluates the depression of the brake.
